(19) United States
(12) Patent Application Publication
(10) Pub. No.: US 2017/0296407 A1
(43) Pub. Date: Oct. 19, 2017

(54) FOLDABLE WHEELCHAIR HAVING A STIFFER CONSTRUCTION

(71) Applicant: Invacare International Sarl, Gland (CH)

(72) Inventors: Rainer Kuschall, Allschwil (CH); Bernard Nicolas, Mulhouse (FR); Simon Brenner, Basel (CH)

(21) Appl. No.: 15/512,601

(22) PCT Filed: Sep. 11, 2015
(86) PCT No.: PCT/IB2015/056964

§ 371 Date: Mar. 20, 2017

(30) Foreign Application Priority Data
Sep. 19, 2014 (EP) 14185669.0

(51) Int. Cl. A61G 5/0883; A61G 5/1054; A61G 5/0816; A61G 5/0866; A61G 5/1078

(52) U.S. Cl. CPC A61G 5/0883; A61G 5/0866; A61G 5/1078; A61G 5/0816; A61G 5/1054

(57) ABSTRACT

The present invention relates to a foldable wheelchair (10) comprising two side frame components (11a, 11b), respectively a left and a right side frame components, each mounting front and rear wheels (12a, 13a; 12b, 13b), respectively left and right, front and rear wheels, said rear wheels (13a, 13b) having an axis of rotation (XX′), said side frame components (11a, 11b) being connected together for relative folding movement between an erected position and a folded position by foldable link element (20) extending between said two side frame components (11a, 11b), wherein the left, respectively the right, side frame component (11a, 11b) comprises a T-shaped bracket (17), along which is connected both a rear wheel suspension (19) of the left, respectively the right, rear wheel (13a, 13b) and a left, respectively a right, end (21a, 22b) of the foldable link element (20), wherein the position of T-shaped bracket (17) is adjustable along the back-to-front direction of the wheelchair so as to permit the adjustment of the position of the center of gravity of the wheelchair.

### TECHNICAL FIELD

The present invention relates in general to foldable wheelchairs. More particularly, the present invention relates to a foldable wheelchair frame having a stiffer construction.

### PRIOR ART AND THE PROBLEM UNDERLYING THE INVENTION

Foldable wheelchairs have been known for some time, and the advantages are numerous with respect to managing the wheelchair when it is not in use, or for transportation of the wheelchair.

For example, U.S. Pat. No. 5,758,897 describes a collapsible wheelchair with two lateral supports on which respectively a drive wheel and respectively a running wheel are fastened and which are rigidly connected by a foldable traverse support.

However, in this prior art, the position of the foldable traverse support relative to the frame can not be modified so as to permit the adjustment of the position of the center of gravity of the wheelchair. Consequently, depending on the position of the rear wheel axis, the distance between said rear wheel axis and said foldable traverse support can vary a lot. This leads to a variable stiffness of the wheelchair that can impact badly on its driving performance. Furthermore, in this prior art, the wheelchair is fully or partially manufactured from heavy metal, such as steel, resulting in a poor portability of the wheelchair.

Thus, a first objective of the present invention is to provide a foldable wheelchair in which the center of gravity can be adjusted by moving the folding mechanism.

A second objective of the present invention is to provide a foldable wheelchair having substantially the same stiffness in every position of the folding mechanism and of the rear wheel axis.

A third objective of the present invention is to provide a foldable wheelchair in which the position of the folding mechanism and of the rear wheel axis can be easily adjusted.

A fourth objective of the present invention is to provide a foldable wheelchair having a reduced weight.

### SUMMARY OF INVENTION

In an aspect, the present invention provides a foldable wheelchair comprising two side frame components, respectively a left and a right side frame components, each mounting front and rear wheels, respectively left and right, front and rear wheels, said rear wheels having an axis of rotation, said side frame components being connected together for relative folding movement between an erected position and a folded position by foldable link element extending between said two side frame components, wherein the left, respectively the right, side frame component comprises a T-shaped bracket, along which is connected both a rear wheel suspension of the left, respectively the right, rear wheel and a left, respectively a right, end of the foldable link element, wherein the position of T-shaped bracket is adjustable along the back-to-front direction of the wheelchair so as to permit the adjustment of the position of the center of gravity of the wheelchair.

Further aspects and preferred embodiments are provided in the appended claims.

### BRIEF DESCRIPTION OF THE DRAWINGS

The wheelchair of the present invention will be described in further detail further below, when useful with reference to the attached drawings, which show an exemplary wheelchair according to the invention.

FIG. 1 is a perspective view of a wheelchair according to the present invention, said wheelchair being in its erected position.

FIG. 2 is a perspective view of the wheelchair of FIG. 1, said wheelchair being in its folded position.

FIG. 3 is a perspective view of the foldable link element of the wheelchair of FIG. 1.

FIG. 4a is a front view of the foldable link element of FIG. 3, in the locked position of the locking lever.

FIG. 4b is a front view of the foldable link element of FIG. 3, in the unlocked position of the locking lever.

FIG. 5a is a perspective view of the right connecting arm of the foldable link element of FIG. 3.

FIG. 5b is an exploded perspective view of the right connecting arm shown in FIG. 5a.

FIG. 6 is a partially exploded perspective view of the connecting structure permitting to link together the foldable link element, the side frame components and the rear wheels of the wheelchair of FIG. 1.

FIG. 7 is a perspective view of a back bracket of the wheelchair of FIG. 1, seen both from the left side and the right side thereof.

FIGS. 8a, 8b and 8c illustrate three different longitudinal positions of the foldable link element relative to the side frame components of the wheelchair of FIG. 1.

### DETAILED DESCRIPTION OF THE PREFERRED EMBODIMENTS

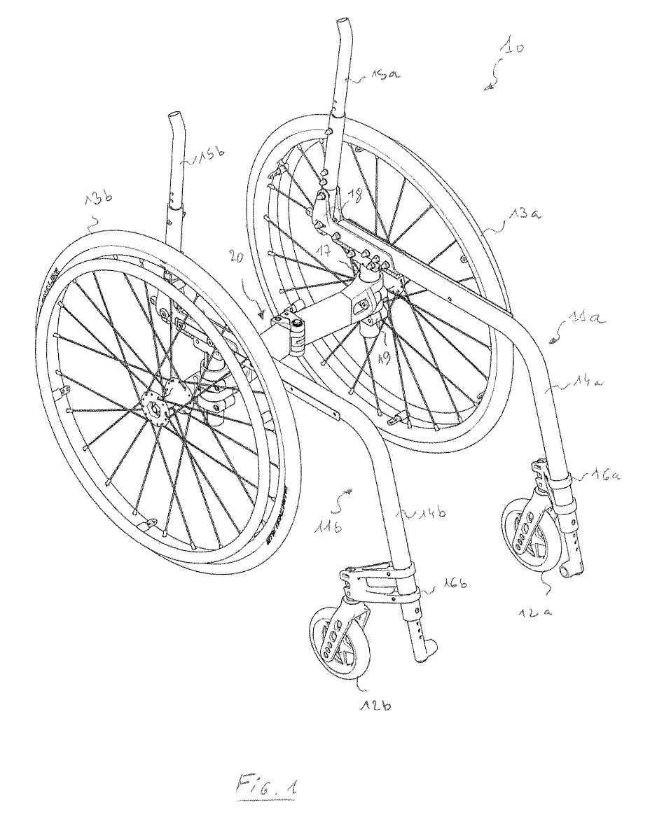

For the purpose of the present specification, situations and directions of elements of the wheelchair of the present invention are determined by the perspective of a user seated in the wheelchair. Accordingly, the left side of the wheelchair corresponds to the right side of FIG. 1. The situations or directions “up” or “top” and “down” or “bottom”, “rear” or “back” and “front”, “behind” and “in front”, “upper” and “lower”, “lateral” and “central” follow the same rule. A longitudinal direction corresponds to a back-to-front direction and a lateral direction corresponds to a left-to-right direction. The horizontal corresponds to the plane tangential to the rear and front wheels and positioned under said wheels when the wheelchair is its normal position of use. A horizontal plane corresponds to a plane parallel to the horizontal. The vertical, or a vertical plane, corresponds to a plane perpendicular to the horizontal.

FIG. 1 shows a foldable wheelchair according to the present invention in which the seat, the backrest, the armrest, the footrest are not shown. This wheelchair may be a dismountable wheelchair, meaning that at least a part of the wheelchair can be reversibly removed from the wheelchair. In this way, it is possible to remove at least one part, for example for the purpose of repairing the part or in order to arrange the wheelchair in a more space-saving manner, for example for storage and/or transport of the wheelchair. The wheelchair 10 of FIG. 1 includes a left side frame component 11a and a right side frame component 11b with front and rear wheels 12a, 13a and 12b, 13b, respectively, extending downwardly therefrom for engaging the ground. The right side frame component 11b is identical to the left side frame component 11a. The left side frame component 11a and the right side frame component 11b are connected together via a foldable link element 20. The left side frame component 11a, respectively the right side frame component 11b, comprises an L-shaped pipe 14a, respectively 14b, having a first horizontal section adapted to support the seat and a second inclined section adapted to support the footrest, and a vertical pipe 15a, respectively 15b, adapted to support the backrest. The L-shape pipe 14a, respectively 14b, and the vertical pipe 15a, respectively 15b, are connected together via a back bracket 18. The left and right side frame components 11a, 11b are preferably made up of a lightweight high-strength material, such as aluminium or titanium. The front wheels 12a, 12b are connected to the inclined section of the L-shaped pipes 14a, 14b respectively via front wheel supports 16a, 16b, said front wheel supports being adapted to permit a stepless adjustment of the position of the front wheels along the L-shaped pipes. Furthermore, to improve the driving performance of the wheelchair, said front wheels 12a, 12b may advantageously be positioned in line with the rear wheels 13a, 13b respectively.

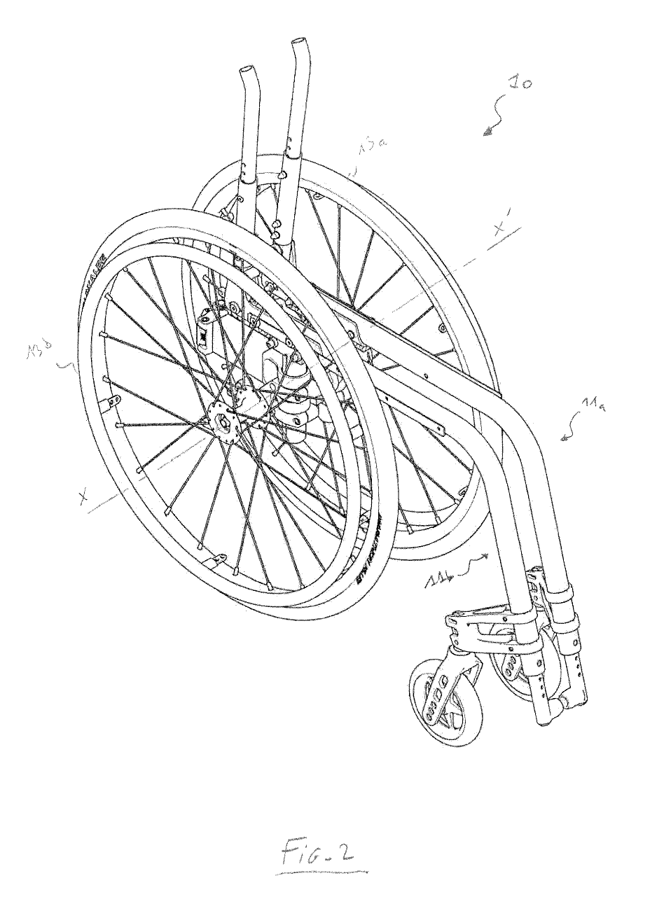

As shown in FIG. 2, the foldable link element 20 can be collapsed to bring the left and right side frame components 11a and 11b into close proximity, thus maintaining the wheelchair 10 into a folded position. During this folding operation, the left and right side frame components 11a, 11b move parallel to the axis XX′ of the rear wheels 13a, 13b.

As shown in FIG. 3, the foldable link element 20 consists in an articulated structure comprising two connecting arms, respectively a left connecting arm 21 pivotally connected around a vertical axis AA′ to the left side frame component 11a at a left end 21a and a right connecting arm 22 pivotally connected around a vertical axis BB′ to the right side frame component 11b at a right end 22b, said connecting arms 21, 22 being hingedly connected together at one other end, respectively a right end 21b for the left connecting arm 21 and a left end 22a for the right connecting arm 22, so that said connecting arms 11a, 11b pivot around a vertical axis CC′ during the folding operation. Thus configured, the foldable link element 20 permits to move the wheelchair 10 from the erected position illustrated in FIG. 1, in which the left and right side frame components 11a, 11b are laterally spaced-apart, to the folded position illustrated in FIG. 2, in which the left and right side frame components 11a, 11b are in close proximity. During the folding operation of the wheelchair, the right end 21b of the left connecting arm 21 and the left end 22a of the right connecting arm 22 move along a back-to-front direction, rearward, relative to the left and right side frame components 11a, 11 b.

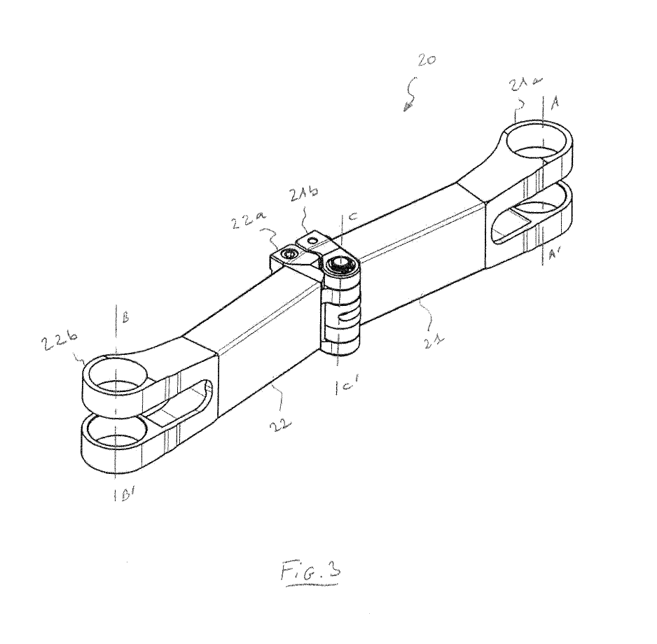

As shown in FIGS. 4a, 4b, the foldable link element 20 may advantageously comprise a locking lever 23 adapted to impede the mutual pivoting movement of the connecting arms 21, 22 in a locked position, as illustrated in FIG. 4a, when the wheelchair is its erected position, and to permit the mutual pivoting movement of the connecting arms 21, 22 in an unlocked position, as illustrated in FIG. 4b, thereby permitting the positioning of the wheelchair in its folded position. In particular, in the embodiment shown, the locking lever 23 consists in a small rectangular plate 231 pivotally connected at its right end to the right connecting arm 22, said plate 231 defining at its left end an abutment 232 against which abuts a protruding part 21c of the left connecting arm 21 when the wheelchair is its erected position and the locking lever is in its locked position. In this specific position, the protruding part 21c abuts also against a similar protruding part 22c of the right connecting arm 22. Therefore, to unlock the wheelchair from its erected position, the user must pivot the locking lever 23 in the counter-clockwise direction until the protruding part 21c does not abut any more against the abutment 232, thereby permitting the pivoting movement of the left connecting arm 21 around the axis CC′ in the clockwise direction. In a further embodiment not shown, the locking lever 23 may alternatively be pivotally connected to the left connecting arm 21, so that the protruding part 22c abuts against the abutment 232 when the wheelchair is in its erected position and the locking lever is in its locked position. A spring (not shown) may advantageously be provided so as to force the locking lever to return to its locked position when it is in its unlocked position.

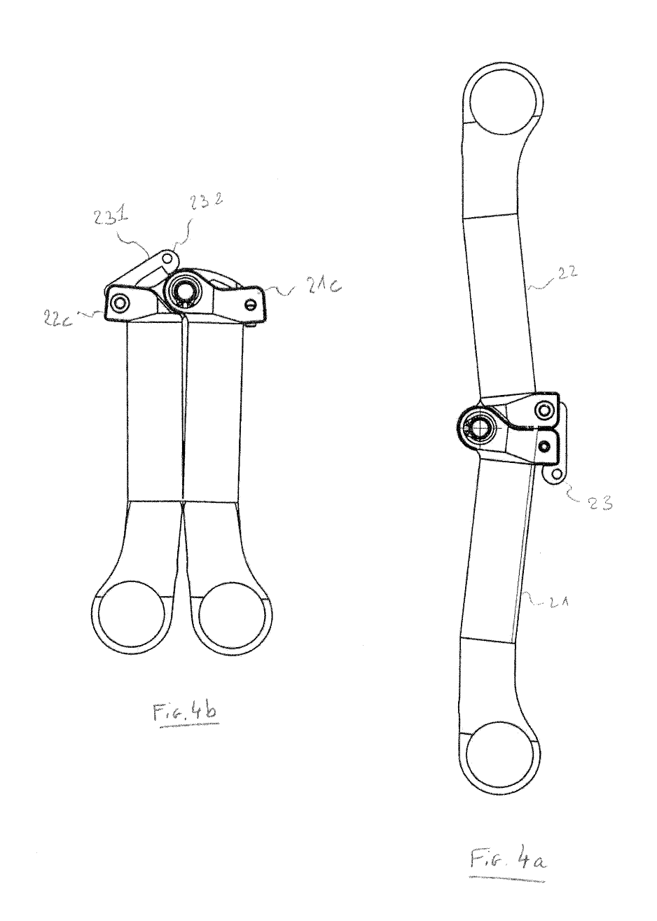

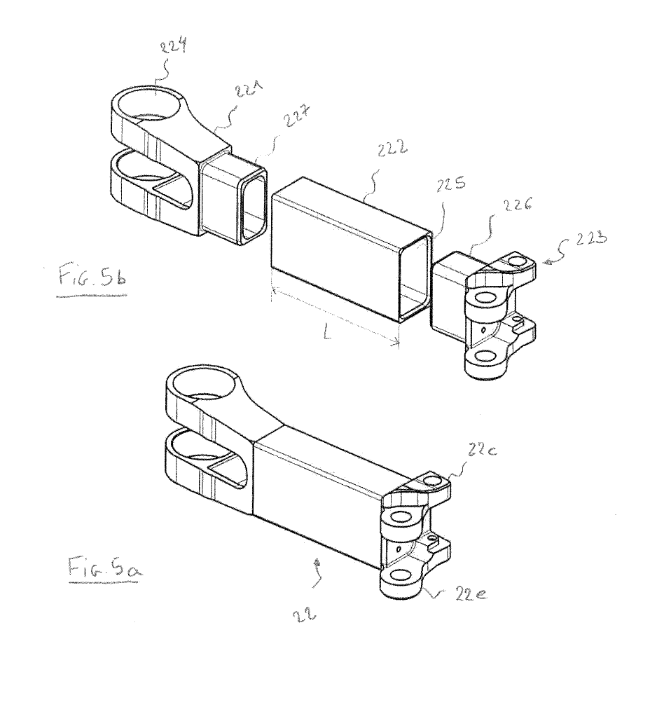

FIGS. 5a, 5b illustrate an advantageous configuration of the right connecting arm 22. This configuration being exactly the same for the left connecting arm 21, it is easier and cheaper to manufacture the wheelchair of the present invention. In particular, this specific configuration limits the number of manufacturing steps due to the fact that one uses only one type of connecting arm for assembling the foldable link element 20. The only difference between the left and the right connecting arms 21, 22 is their relative orientation when assembled in the foldable link element 20, the left connecting arm 21 being oriented so that the protruding part 21c, corresponding to the lower protruding part 22e shown in FIG. 5a, is in contact with the upper protruding part 22c shown in FIG. 5a. As illustrated in FIG. 5b, the right connecting arm 22 may advantageously be formed by assembling three separate parts, respectively a central part 222 fixedly connected at its right end to a distal part 221 and at its left end to a proximal part 223. Said central part 222 may advantageously have a parallelepiped shape with a substantially rectangular cross-section, a central cavity 225 thereof being adapted to receive at the left end of said central part 222 a connecting part 226 of the proximal part 223 and at the right end of said central part 222 a connecting part 227 of the distal part 221. Said connecting parts 226, 227 may advantageously be connected to said central part 222 by an adhesive or glue. The distal part 221 may advantageously define a fork with two prongs, each prong being provided with a cylindrical aperture 224 adapted to receive an axle of the right side frame component 11b so as to permit the pivoting connection between said right side frame component 11b and said distal part 221. This configuration permits to easily adapt the length of the foldable link element 20, and thus the width of the wheelchair, to the needs of the user. Indeed, in this configuration, the distal part 221 and the proximal part 223 of the right connecting arm 22, and the corresponding distal and proximal parts of the left connecting arm 21, are independent of the width of the wheelchair. Therefore, the width of the wheelchair depends mainly on the length L of the central part 222 of the right connecting arm 22 and on the length of the corresponding central part of the left connecting arm 21. This configuration is also advantageous for the stiffness of the wheelchair, due to the fact that the substantially rectangular shape of the foldable link element 20 contributes to an excellent distribution of forces through said foldable link element.

FIG. 6 illustrates a preferred configuration of the connecting structure permitting to link together the foldable link element 20, the side frame components 11a, 11b and the rear wheels 13a, 13b. This connecting structure comprises left and right rear wheel suspensions 19 adapted to receive the axle of left and right rear wheels 13a, 13b respectively and configured so as to be fixedly connected to a T-shaped bracket 17, said T-shaped bracket 17 being fixedly connected to the back bracket 18 of the corresponding side frame component 11a or 11b. Said rear wheel suspensions 19 may advantageously comprise four different link components, i.e. a distal link component 191, upper and lower central link components 192i, 192j fixedly connected to said distal link component 191, by screws or bolts for instance, and a proximal link component 193 fixedly connected to the upper central link component 192i, preferably by the same screw or bolt used for connecting the upper central link component 192i to the distal link component 191, and configured so as to prevent the vertical movement of the foldable link element 20 but without impeding its pivoting movement around the axes AA′ and BB′ respectively defined by the vertical leg 171 of the corresponding T-shaped brackets 17. In particular, distal and upper central link components 191, 192i may advantageously be designed so as to enclose the vertical leg 171 between an upper hemi-cylindrical groove 191i of the distal link component 191 and a corresponding hemi-cylindrical groove of the upper central link component 192i in an area of said vertical leg 171 positioned between the two prongs of the distal part 211 or 221 of left and right connecting arms 21, 22 respectively. Similarly, distal and lower central link components 191, 192j may advantageously be designed so as to enclose the vertical leg 171 between a lower hemi-cylindrical groove 191j of the distal link component 191 and a corresponding hemi-cylindrical groove of the lower central link component 192i in an area of said vertical leg 171 positioned below said two prongs. Thus configured, the left and right rear wheel suspensions 19 can be fixedly connected to a corresponding T-shaped bracket 17 by clamping, said connection permitting the stepless adjustment of the position of said rear wheel suspensions, and thus of the left and right connecting arms 21, 22, along the axes AA′ and BB′ respectively, thereby permitting the stepless adjustment of the height of the seat. The proximal link component 193 may advantageously be T-shaped, the leg of the T extending inside the intermediary area separating each prong of the distal part 211 or 221 of a connecting arm 21 or 22, thereby limiting the vertical movement of the foldable link element 20.

As shown in FIGS. 1, 6 and 7, each T-shaped bracket 17 may advantageously comprise a horizontal branch 172 longitudinally aligned with a corresponding back bracket 18 of the left or right side frame component 11a, 11b, said branch 172 being configured so as to be fixedly attached to a protruding part 185 of said back bracket 18 in one specific longitudinal position chosen among a plurality of positions defined by a plurality of lateral through-holes 186 formed in said protruding part 185. Each through-hole 186 is adapted to partially receive the threaded rod of one of a pair of screw bolts 173, said threaded rod being also partially received in corresponding trough-holes of said branch 172, thereby permitting the attachment of the T-shaped bracket 17 on the back bracket 18 by said screw bolts 173. In the embodiment shown, the branch 172 is advantageously designed so as to define a dovetail-shaped groove inside which is received the dovetail-shaped protruding part 185 of the back bracket 18. The back bracket 18 may advantageously include a longitudinal hollow hemi-cylindrical part 181 adapted to receive the horizontal section of the L-shaped pipe 14a or 14b, said part 181 being provided with several holes 187 so as to permit the fixed connection thereof to said section by screw bolts. Furthermore, said back bracket 18 may advantageously include a pair of space-apart vertical branches 182 adapted to receive a lower end of the vertical pipe 15a or 15b, each of said branches 182 being provided with one upper hole 183 and one lower slit 184, said lower slit 184 being provided with a series of housings defining a series of specific inclined positions for the L-shaped pipe 14a or 14b, so as to permit the fixed connection of said L-shaped pipe 14a or 14b to said back bracket 18 in one of said specific inclined positions when corresponding screw bolts are positioned in said upper hole 183 and said lower slit 184, thereby permitting an angle adjustability and folding of the backrest.

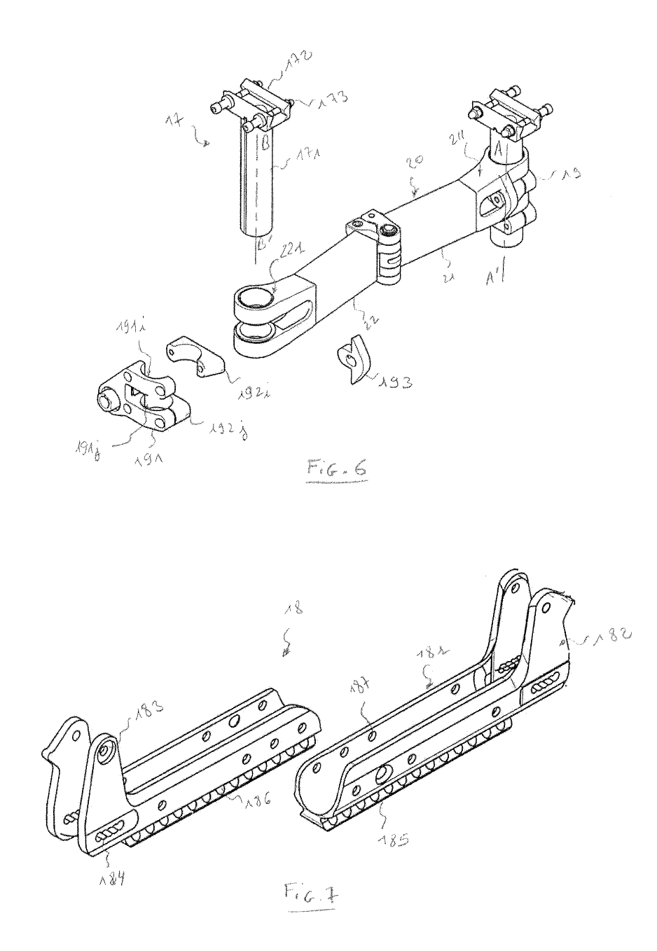

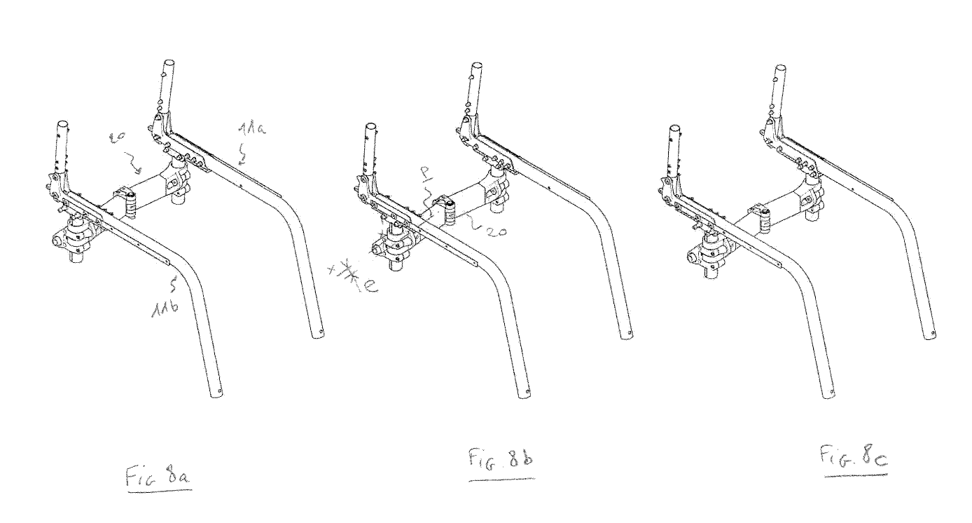

As illustrated in FIGS. 8a, 8b and 8c, the preferred configuration of FIGS. 6 and 7 permits to move the T-shaped bracket 17, together the rear wheel suspensions 19, along the back-to-front direction relative to the back bracket 18, thereby permitting the longitudinal adjustment in steps of the position of the center of gravity of the wheelchair. Furthermore, due to the minimized longitudinal distance e between the rear wheel axis XX′ and the plane P defined by the foldable link element 20 in the erected position of the wheelchair, the flexibility within the wheelchair is reduced, thereby enhancing the driving performance of the wheelchair. Preferably, said distance is less than 50 mm, and more preferably is approximately equal to zero.

The above detailed description with reference to the drawings illustrates rather than limits the invention. There are numerous alternatives, which fall within the scope of the appended claims.

1-15. (canceled)

16. A foldable wheelchair comprising:
left and right side frame components having each mounting front and rear wheels,
said rear wheels having an axis of rotation, said left and right side frame components being connected together for relative folding movement between an erected position and a folded position by foldable link element extending between said left and right side frame components,
wherein the left and the right side frame components comprise a T-shaped bracket, along which is connected both a rear wheel suspension of the left and the right rear wheels and a left and a right end of the foldable link element,
wherein the position of T-shaped bracket is adjustable along the back-to-front direction of the wheelchair so as to permit the adjustment of the position of the center of gravity of the wheelchair.

17. The foldable wheelchair of claim 16, wherein the foldable link element substantially defines a plane and wherein the rear wheel suspension of the left and right rear wheels is configured so that the distance between the rear wheel axis and said plane is minimized.

18. The foldable wheelchair of claim 17, wherein the distance between the rear wheel axis and said plane is less than 50 mm.

19. The foldable wheelchair of claim 17, wherein the distance between the rear wheel axis and said plane is approximately equal to zero.

20. The foldable wheelchair of claim 16, wherein the foldable link element comprises a left connecting arm pivotally connected around a first vertical axis to the left side frame component at a left end and a right connecting arm pivotally connected around a second vertical axis to the right side frame component at a right end, said connecting arms being pivotally connected together around a third vertical axis at one other end such that said left and right side frame components move closer to each other and said other ends moves along the back-to-front direction of the wheelchair when the wheelchair moves from its erected position to its folded position.

21. The foldable wheelchair of claim 20, wherein the foldable link element comprises a locking lever adapted to impede the mutual pivoting movement of the connecting arms in a locked position, thereby locking the wheelchair in its erected position, and to permit the mutual pivoting movement of said connecting arms in an unlocked position, thereby unlocking the wheelchair from its erected position.

22. The foldable wheelchair of claim 16, wherein the position of the rear wheel suspension of the left and the right rear wheels relative to the T-shaped bracket is stepless vertically adjustable.

23. The foldable wheelchair of claim 22, wherein the rear wheel suspension of the left and right rear wheels is fixedly connected to the T-shaped bracket by clamping.

24. The foldable wheelchair of claim 16, wherein the foldable link element is integral with the rear wheel suspensions when the rear wheel suspensions move along a vertical direction.

25. The foldable wheelchair of claim 16, wherein the left and right side frame components comprise a L-shaped pipe, said L-shaped pipe having a horizontal section adapted to support a seat of the wheelchair and an inclined section adapted to support a footrest of the wheelchair, and a vertical pipe adapted to support a backrest of the wheelchair, said L-shaped pipe and said vertical pipe being connected together via a back bracket.

26. The foldable wheelchair of claim 25, wherein the back bracket is configured so as to permit the angle adjustability of the vertical pipe relative to the L-shaped pipe.

27. The foldable wheelchair of claim 25, wherein the T-shaped bracket comprises a vertical leg adapted to be fixedly connected to the rear wheel suspension of the left and right rear wheels and a horizontal branch fixedly connected to the back bracket of the left and right side frame components.

28. The foldable wheelchair of claim 27, wherein said back bracket being configured so as to permit the longitudinal adjustment of the position of the T-shaped bracket relative to the left and right side frame components.

29. The foldable wheelchair of claim 20, wherein the left and the right connecting arms have the same shape.

30. The foldable wheelchair of claim 27, wherein the right and left connecting arms comprise three separate parts, a central part fixedly connected to a distal part pivotally connected to the right or left side frame component and to a proximal part pivotally connected to a corresponding proximal part of the connecting arm.

31. The foldable wheelchair of claim 28, wherein the central part has a parallelepiped shape with a substantially rectangular cross-section and is provided with a central cavity adapted to receive at one end a connecting part of the proximal part and at the other end a connecting part of the distal part.

32. The foldable wheelchair of claim 29, wherein the connecting parts of the proximal and distal parts are fixedly connected to the central part by an adhesive or glue.
